(19) United States
(12) Patent Application Publication
(10) Pub. No.: US 2007/0172756 A1
(43) Pub. Date: Jul. 26, 2007

(54) Photosensitive resin composition, photosensitive element comprising the same, process for producing resist pattern, and process for producing printed wiring board

(76) Inventors: Chikara Ishikawa, Ibaraki (JP); Mitsuaki Watanabe, Ibaraki (JP); Naoki Sasahara, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/588,498

(22) PCT Filed: Sep. 3, 2004
(86) PCT No.: PCT/JP04/12816

§ 371 Date: Aug. 4, 2006

(30) Foreign Application Priority Data
Feb. 5, 2004 (JP) 2004-029266

(51) Int. Cl. G03C 1/00

(52) U.S. Cl. 430/270.1; 430/311

(57) ABSTRACT

A photosensitive resin composition comprising (A) a binder polymer, (B) a photopolymerizing compound with at least one polymerizable ethylenic unsaturated group in the molecule and (C) a photopolymerization initiator, wherein component (B) contains a compound represented by the following general formula (2). 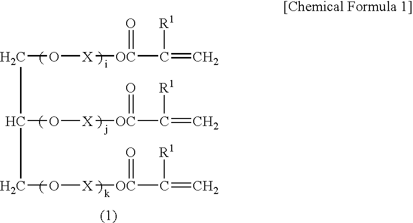
(wherein the three R¹ groups each independently represent hydrogen or methyl, the three X groups each independently represent C2-6 alkylene and i, j and k each independently represent an integer of 1-14.)

### TECHNICAL FIELD

The present invention relates to a photosensitive resin composition, a photosensitive element, a resist pattern forming method and a print circuit board production process employing it.

### BACKGROUND ART

Photosensitive elements comprising supports and photosensitive resin composition layers (photosensitive layers) are used as resists that are employed in the fields of printed circuit boards and metal precision working. A photosensitive element is usually formed by laminating a photosensitive resin composition layer on a support and, in most cases, further laminating a protecting film (protective film) on the photosensitive resin composition layer.

The uses of photosensitive elements are largely of two kinds: uses for circuit formation and uses for solder resists.

Circuit-forming photosensitive elements are used to form circuits by such methods as subtractive methods or etched foil methods. Subtractive methods are methods wherein a circuit-forming board such as a glass epoxy board having its surface and through-hole inner walls coated with a copper layer is used and the excess copper is etched away to form a circuit, and such methods are further subdivided into tenting and plating methods.

In a tenting method, the chip part-mounting copper through-holes are protected with a resist film and circuit formation is accomplished by etching and resist film removal, and therefore a high resist film strength is preferred. A plating method, on the other hand, is the reverse of tenting in that the through-holes and the sections other than those that are to form the circuit are coated with a resist film and a copper surface is solder plated on the sections not coated with the resist film, after which the resist film is removed to form a solder plating pattern and then etching is performed with the solder plating pattern as the resist against the etching solution, in order to form a circuit.

In the tenting method, adhesion between the resist and copper is essential to avoid seepage of the etching solution between the resist film and copper. If the etching solution seeps between the resist and copper, the copper at sections that are to form the circuit become etched, resulting in circuit breakage.

In the plating method as well as in the tenting method, adhesion between the resist and copper is essential in order to avoid leaking of the plating between the resist and copper. If the plating leaks between the resist and the copper, the plating pattern forms on undesired sections and in the subsequent etching, copper will remain at sections where no circuit formation is desired.

Printed circuit board production processes employing photosensitive elements based on subtractive methods may be summarized as follows.

After first releasing the protective film, a photosensitive element is laminated onto the circuit-forming board such as a copper clad laminate. Next, the support is removed if necessary, and exposure is carried out through a positive or negative film such as a wiring pattern mask film for curing of the resist at the exposed sections. When the support remains after exposure, it is released if necessary and a developing solution is used for dissolving or dispersing removal of the photosensitive resin composition layer at the non-exposed sections, to form a cured resist image on the circuit-forming board. Photosensitive resin composition layers that are known include alkali-developing types wherein an aqueous alkali solution is used as the developing solution, and solvent-developing types wherein an organic solvent is used as the developing solution. Alkali-developing photosensitive elements are in greater demand due to recent environmental and cost considerations. The developing solution used is normally one having some ability to dissolve the photosensitive resin composition layer, and during its use the photosensitive resin composition is dissolved or dispersed in the developing solution.

The cured resist film formed by exposure and development is released and removed by etching, or it is released and removed using an aqueous alkali solution such as sodium hydroxide after plating. The rate of release is preferably rapid from the standpoint of workability, handleability and productivity.

Moreover, the increasing densification of printed circuits in recent years, and the consequent reduction in contact area between copper boards and pattern-formed photosensitive resin compositions, are leading to greater requirements for excellent adhesive force, mechanical strength, chemical resistance and flexibility, as well as high resolution, in the development, etching and plating treatment steps. For improvement in chemical resistance among these properties, Patent documents 1 to 5, for example, describe cured resist films obtained from photosensitive resin composition employing binder polymers produced by copolymerization of styrene-based monomers.

The cured resist films described in these documents exhibit enhanced mechanical strength due to improved chemical resistance. However, such cured resist films also tend to have lower flexibility and poor mechanical impact resistance. Because damage to the cured resist film can thus result in peeling and the like in printed circuit board production processes, the photosensitive resin compositions described in the aforementioned publications are not satisfactory for high densification and high resolution.

Patent document 6 discloses an acrylate-based compound with a polyethylene glycol chain alone as a photosensitive resin composition material, but because of excessively strong hydrophilicity with only polyethylene glycol chains, inconveniences may occur such as poor tent reliability and impaired resist shape. On the other hand, when an acrylate compound having only a polypropylene glycol chain is used as a photosensitive resin composition material, drawbacks include lack of improvement in resolution, ready separation in the alkali developing solution and generation of scum, while attachment to boards can lead to shorting and breaks. Thus, even using such acrylate-based compounds cannot provide adequate high densification and high resolution for printed circuit boards.

As explained above, achieving adequate high densification and high resolution for printed circuit boards requires a cured resist film with better adhesion than provided by the prior art.
[Patent document 1] Japanese Examined Patent Publication No. S54-25957
[Patent document 2] Japanese Examined Patent Publication No. S55-38961
[Patent document 3] Japanese Patent Application Laid-Open No. H2-289607
[Patent document 4] Japanese Patent Application Laid-Open No. H4-285960
[Patent document 5] Japanese Patent Application Laid-Open No. H4-347859
[Patent document 6] Japanese Patent Application Laid-Open No. H5-232699

### DISCLOSURE OF THE INVENTION

### Problems to be Solved by the Invention

It is an object of the present invention to provide a photosensitive resin composition which can yield cured resist films that in particular exhibit a sufficiently excellent adhesive property in order to achieve adequate high densification and high resolution for printed circuit boards, as well as a photosensitive element, a resist pattern forming method and a print circuit board production process employing it.

### Means for Solving the Problems

In order to solve the problems described above, the present invention provides a photosensitive resin composition comprising (A) a binder polymer, (B) a photopolymerizing compound with at least one polymerizable ethylenic unsaturated group in the molecule and (C) a photopolymerization initiator, wherein component (B) contains a compound represented by the following general formula (1).

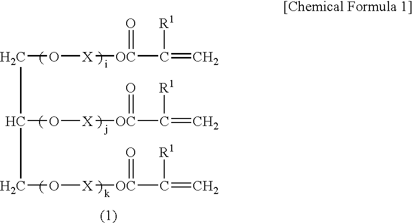

In formula (1), the three R¹ groups each independently represent hydrogen or methyl, the three X groups each independently represent C2-6 alkylene and i, j and k each independently represent an integer of 1-14.

Such a photosensitive resin composition is useful for high densification and high resolution of printed circuits. The photosensitive resin composition can also be used to provide a photosensitive element with an excellent adhesive property as well as excellent photosensitivity, resolution, mechanical strength and flexibility.

The alkylene group of component (B) is preferably ethylene or propylene in order to exhibit the aforementioned effect more actively and reliably.

From the standpoint of further improving the adhesive property, the compound represented by general formula (1) above is preferably a compound represented by the following general formula (2).

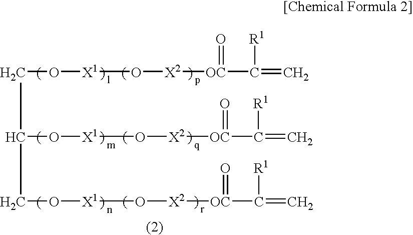

In formula (2), the three R¹ groups each independently represent hydrogen or methyl, the three X¹ and three X² groups each independently represent C2-6 alkylene and l, m, n, p, q and r each independently represent an integer of 1-7. X¹ and X² on the same chain are preferably different alkylene groups.

In order to achieve even greater densification and higher resolution for printed circuits, preferably either X¹ or X² of the compound represented by general formula (2) above is ethylene while the other is propylene, and more preferably X¹ and X² are ethylene and propylene, respectively. Alternatively, X¹ may be ethylene and X² may be an alkylene group other than propylene.

In the compound represented by general formula (1) above, i, j and k are preferably 1-7 from the standpoint of improving the adhesive property of the cured resist film and shortening the release time. From the same standpoint, more preferably l, m, n, p, q and r of the compound represented by general formula (2) above are each independently an integer of 1-3.

The weight-average molecular weight of component (A) is preferably 10,000-95,000. Using component (A) and component (B) together can further improve the resolution and adhesive property.

The photosensitive resin composition of the invention preferably has a component (A) content of 40-80 parts by weight, a component (B) content of 20-60 parts by weight and a component (C) content of 0.1-20 parts by weight with respect to 100 parts by weight as the total of component (A) and component (B). Including each component in the composition within these numerical ranges will tend to prevent embrittlement of the photosensitive layer, improve coatability and maintain high photosensitivity.

The content of the compound represented by general formula (1) is preferably 3-60 wt % with respect to the total of component (B), from the viewpoint of maintaining mechanical impact resistance of the cured resist film and shortening the release time.

The present invention also provides a photosensitive element comprising a support and a photosensitive layer composed of the aforementioned photosensitive resin composition formed on the support. A photosensitive element of the invention can achieve adequate high densification and high resolution for printed circuits, as well as an excellent adhesive property and excellent photosensitivity, mechanical strength and flexibility.

The thickness of the support of the photosensitive element of the invention is preferably 5-25 μm from the standpoint of facilitating release of the support and achieving high resolution.

The support also preferably has a haze of 0.001-5.0. A haze value within this numerical range will allow high resolution to be maintained.

The photosensitive layer of the photosensitive element of the invention preferably has an ultraviolet light transmittance of 5-75% at a wavelength of 365 nm, for further enhanced adhesion and resolution.

Providing a protective film on the photosensitive layer of the photosensitive element of the invention is preferred in order to facilitate handling of the photosensitive element and improve productivity and storage stability.

The thickness of the protective film is preferably 5-30 μm from the standpoint of cost reduction and preventing tearing of the protective film.

The tensile strength of the protective film in the lengthwise direction of the film is preferably at least 13 MPa and/or the tensile strength of the protective film in the widthwise direction of the film is preferably at least 9 MPa, in order to inhibit tearing of the protective film.

The present invention further provides a resist pattern forming method wherein the photosensitive layer for the aforementioned photosensitive element is laminated on a circuit-forming board and active light rays are irradiated onto prescribed sections of the photosensitive layer for photocuring of the exposed sections, after which the non-exposed sections of the photosensitive layer are removed. When the photosensitive element includes a protective film, the protective film is released at the time the photosensitive layer is laminated on the circuit-forming board and the active light rays are irradiated onto prescribed sections of the photosensitive layer for photocuring of the exposed sections, after which the non-exposed sections of the photosensitive layer are removed. The resist pattern forming method can provide excellent photosensitivity, resolution, adhesion, mechanical strength, flexibility, workability and productivity.

The present invention further provides a printed circuit board production process wherein a circuit-forming board having a resist pattern formed thereon by the aforementioned resist pattern forming method is etched or plated. The printed circuit board production process of the invention can provide excellent photosensitivity, resolution, adhesion, mechanical strength, flexibility, environmental suitability, workability and productivity.

### Effect of the Invention

According to the present invention there are provided a photosensitive resin composition that can yield a cured resist film with sufficiently excellent adhesive properties, as well as a photosensitive element, a resist pattern forming method and a print circuit board production process employing it.

### BRIEF EXPLANATION OF THE DRAWINGS

FIG. 1 is a schematic cross-sectional view showing an embodiment of a photosensitive element of the invention.

FIG. 2 is a process diagram showing an embodiment of a printed circuit board production process according to the invention.

### EXPLANATION OF SYMBOLS

1: photosensitive element, 11: support, 12: photosensitive layer, 13: protective film, 20: insulating sheet, 30: metal foil, 31: wiring pattern, 40: photomask, 41: transparent sections, 42: non-transparent sections, 50: circuit-forming board, 60: printed circuit board, 121: cured sections, 122: non-cured sections

### BEST MODE FOR CARRYING OUT THE INVENTION

Preferred embodiments of the invention will now be explained in detail, with reference to the accompanying drawings as necessary. Throughout the drawings, corresponding elements will be referred to by like reference numerals and will be explained only once. Unless otherwise specified, the vertical and horizontal positional relationships are based on the positional relationships in the drawings. The dimensional proportions in the drawings are not restricted to the proportions shown. The term “(meth)acrylic acid” used throughout the present specification refers to “acrylic acid” and its corresponding “methacrylic acid”, the term “(meth)acrylate” refers to “acrylate” and its corresponding “methacrylate”, the term “(meth)acryloyl” refers to “acryloyl” and its corresponding “methacryloyl”, and the term “(meth)acryloxy” refers to “acryloxy” and its corresponding “methacryloxy”.

The photosensitive resin composition of the invention comprises (A) a binder polymer, (B) a photopolymerizing compound with at least one polymerizable ethylenic unsaturated group in the molecule and (C) a photopolymerization initiator.

The (A) binder polymer is not particularly restricted, and as examples there may be mentioned acrylic-based resins, styrene-based resins, epoxy-based resins, amide-based resins, amide-epoxy-based resins, alkyd-based resins and phenol-based resins. Acrylic-based resins are preferred among these from the viewpoint of alkali developing properties. Any of these may be used alone, or two or more thereof may be used in combination.

The (A) binder polymer may be produced, for example, by radical polymerization of a polymerizable monomer. As examples of such polymerizable monomers there may be mentioned styrene, polymerizable styrene derivatives substituted at the α-position or on the aromatic ring, such as vinyltoluene, α-methylstyrene and the like, acrylamides such as diacetoneacrylamide, acrylonitrile, vinyl alcohol esters such as vinyl-n-butyl ether, (meth)acrylic acid alkyl esters, (meth)acrylic acid tetrahydrofurfuryl ester, (meth)acrylic acid dimethylaminoethyl ester, (meth)acrylic acid diethylaminoethyl ester, (meth)acrylic acid glycidyl ester, 2,2,2-trifluoroethyl(meth)acrylate, 2,2,3,3-tetrafluoropropyl(meth)acrylate, (meth)acrylic acid, α-bromo(meth)acrylic acid, α-chloro(meth)acrylic acid, β-furyl(meth)acrylic acid, β-styryl(meth)acrylic acid, maleic acid, maleic anhydride, maleic acid monoesters such as monomethyl maleate, monoethyl maleate and monoisopropyl maleate, fumaric acid, cinnamic acid, α-cyanocinnamic acid, itaconic acid, crotonic acid, propiolic acid, and the like.

As examples of the aforementioned (meth)acrylic acid alkyl esters there may be mentioned compounds represented by the following general formula (3), or those compounds substituted at the alkyl group with hydroxyl, epoxy, halogens and the like.
CH₂═C(R²)—COOR³ (3)
In this formula, R² represents hydrogen or methyl, and R³ represents a C1-12 alkyl group.

As examples of C1 -12 alkyl groups represented by R³ in general formula (3) above there may be mentioned methyl, ethyl, propyl, butyl, pentyl, hexyl, heptyl, octyl, nonyl, decyl, undecyl, dodecyl and their structural isomers. As examples of monomers represented by general formula (3) above there may be mentioned (meth)acrylic acid methyl ester, (meth)acrylic acid ethyl ester, (meth)acrylic acid propyl ester, (meth)acrylic acid butyl ester, (meth)acrylic acid pentyl ester, (meth)acrylic acid hexyl ester, (meth)acrylic acid heptyl ester, (meth)acrylic acid octyl ester, (meth)acrylic acid 2-ethylhexyl ester, (meth)acrylic acid nonyl ester, (meth)acrylic acid decyl ester, (meth)acrylic acid undecyl ester and (meth)acrylic acid dodecyl ester. Any of these may be used alone, or two or more thereof may be used in combination.

The binder polymer as component (A) according to the invention preferably has a carboxyl group in the molecule from the standpoint of alkali developing properties, and it may be produced, for example, by radical polymerization of a polymerizable monomer with a carboxyl group and another polymerizable monomer. The binder polymer as component (A) according to the invention also preferably contains styrene or a styrene derivative as a polymerizable monomer from the standpoint of enhancing the adhesion, resolution, release property and chemical resistance.

In order to achieve satisfactory adhesion, resolution and release properties when using styrene or a styrene derivative as a copolymerizing component, the styrene or styrene derivative content is preferably 2-40 wt %, more preferably 3-35 wt %, even more preferably 5-30 wt % and most preferably 7-25 wt % of the total polymerizable monomer. If the content is less than 2 wt % the adhesion and resolution will tend to be inferior, and if it is greater than 40 wt %, peel strips will be larger and the release time will tend to be longer.

From the standpoint of improving the developing solution resistance and shortening the development time, the weight-average molecular weight of the (A) binder polymer is preferably 10,000-300,000, more preferably 20,000-300,000, even more preferably 40,000-150,000, yet more preferably 50,000-70,000, even yet more preferably 55,000-65,000 and most preferably about 60,000. A weight-average molecular weight of less than 10,000 will tend to result in lower developing solution resistance, and greater than 300,000 will tend to lengthen the developing time. The abbreviation “Mw” throughout the present specification is the weight-average molecular weight based on standard polystyrene according to gel permeation chromatography (GPC).

From the standpoint of improving the developing solution resistance and resolution, the weight-average molecular weight of the (A) binder polymer is preferably 10,000-95,000, more preferably 10,000-60,000 and even more preferably 20,000-50,000. A weight-average molecular weight of less than 10,000 will tend to result in lower developing solution resistance, and greater than 95,000 will tend to lower the resolution.

The acid value of the (A) binder polymer is preferably 30-250 mgKOH/g and more preferably 50-200 mgKOH/g. If the acid value is less than 30 mgKOH/g the developing time will tend to be delayed, and if it is greater than 250 mgKOH/g the developing solution resistance of the photocured resist will tend to be reduced.

Such (A) binder polymers may be used alone or in combinations of two or more. As examples of binder polymers when two or more are used in combination, there may be mentioned two or more binder polymers composed of different copolymerizable components, two or more binder polymers with different weight-average molecular weights, and two or more binder polymers with different dispersibilities.

The (B) photopolymerizing compound with at least one polymerizable ethylenic unsaturated group in the molecule contains a compound represented by general formula (1) below as an essential component.

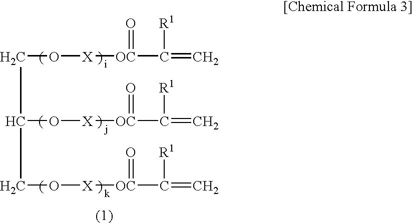

In formula (1), the three R¹ groups each independently represent hydrogen or methyl, with hydrogen being preferred from the standpoint of improved resolution.

Also in formula (1), the three X groups each independently represent C2-6 alkylene. As examples of C2-6 alkylene groups there may be mentioned ethylene, propylene, trimethylene, butylene, amylene and hexylene. Isomeric structures of butylene, amylene and hexylene exist, and the compounds used for the invention are not limited to a single structural isomer.

From the viewpoint of improving adhesion and shortening the release time, as well as achieving greater densification and higher resolution of printed circuit boards in the production of printed circuit boards, the alkylene group is preferably ethylene or propylene.

In formula (1) above, i, j and k each independently represent an integer of 1-14. From the viewpoint of improving adhesion and shortening the release time, i, j and k each independently represent preferably an integer of 1-12, more preferably an integer of 1-8, even more preferably an integer of 1-7, yet more preferably an integer of 1-6 and most preferably an integer of 1-3.

The compound represented by general formula (1) above is preferably a compound represented by the following general formula (2), in order to achieve even better adhesion of the cured resist film.

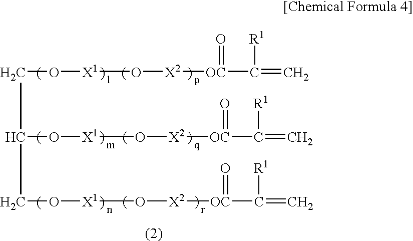

In formula (2), the three R¹ groups each independently represent hydrogen or methyl, with hydrogen being preferred from the standpoint of improved resolution.

Also in formula (2), the three X¹ groups and three X² groups each independently represent C2-6 alkylene. As examples of C2-6 alkylene groups there may be mentioned ethylene, propylene, trimethylene, butylene, amylene and hexylene. Isomeric structures of butylene, amylene and hexylene exist, and the compounds used for the invention are not limited to a single structural isomer.

From the viewpoint of improving adhesion and shortening the release time, as well as achieving greater densification and higher resolution of printed circuit boards in the production of printed circuit boards, one of X¹ and X² is preferably ethylene while the other is propylene, and more preferably X¹ and X² are ethylene and propylene, respectively.

X¹ and X² on the same chain are preferably different alkylene groups. In formula (2), the X¹ of —(O—X¹)₁— and the X² of —(O—X²)ₚ—, the X¹ of —(O—X¹ )_{m— and the X}² of —(O—X²)_{q}—, and the X¹ of —(O—X¹)ₙ— and the X² of —(O—X²)ᵣ— correspond to “X¹ and X² on the same chain”.

In formula (2) above, l, m, n, p, q and r each independently represent an integer of 1-7. From the viewpoint of improving adhesion and shortening the release time, l, m, n, p, q and r each independently represent preferably an integer of 1-6, more preferably an integer of 1-4 and most preferably an integer of 1-3.

When at least two of the repeating units —(O—X¹)— and —(O—X²)— of formula (2) are present, the two or more X¹ groups and two or more X² groups may be the same or different. When two or more X¹ groups and two or more X² groups are composed of two or more different alkylene groups, the two or more different —(O—X¹)— and —(O—X²)— groups may occur randomly or may be arranged in a block fashion.

According to the invention, the compound represented by general formula (2) above may be used in combination with another photopolymerizing compound with at least one polymerizable ethylenic unsaturated group in the molecule. There are no particular restrictions on a photopolymerizing compound with at least one polymerizable ethylenic unsaturated group in the molecule used in addition to the compound represented by general formula (2) above, and for example, there may be mentioned compounds obtained by reaction of polyhydric alcohols with α,β-unsaturated carboxylic acids, compounds obtained by reaction of glycidyl group-containing compounds with α,β-unsaturated carboxylic acids, as well as 2,2-bis(4-((meth)acryloxydiethoxy)phenyl)propane, nonylphenyldioxyalkylene(meth)acrylate, γ-chloro-β-hydroxypropyl-β′-(meth)acryloyloxyethyl-o-phthalate, β-hydroxyethyl-β′-(meth)acryloyloxyethyl-o-phthalate, (meth)acrylic acid alkyl ester and the like.

As examples of 2,2-bis(4-((meth)acryloxypolyethoxy)phenyl)propanes there may be mentioned 2,2-bis(4-((meth)acryloxydiethoxy)phenyl)propane, 2,2-bis(4-((meth)acryloxytriethoxy)phenyl)propane, 2,2-bis(4-((meth)acryloxytetraethoxy)phenyl)propane, 2,2-bis(4-((meth)acryloxypentaethoxy)phenyl)propane, 2,2-bis(4-((meth)acryloxyhexaethoxy)phenyl)propane, 2,2-bis(4-((meth)acryloxyheptaethoxy)phenyl)propane, 2,2-bis(4-((meth)acryloxyoctaethoxy)phenyl)propane, 2,2-bis(4-((meth)acryloxynonaethoxy)phenyl)propane, 2,2-bis(4-((meth)acryloxydecaethoxy)phenyl)propane, 2,2-bis(4-((meth)acryloxyundecaethoxy)phenyl)propane, 2,2-bis(4-((meth)acryloxydodecaethoxy)phenyl)propane, 2,2-bis(4-((meth)acryloxytridecaethoxy)phenyl)propane, 2,2-bis(4-((meth)acryloxytetradecaethoxy)phenyl)propane and 2,2-bis(4-((meth)acryloxypentadecaethoxy)phenyl)propane. These may be used alone or in combinations of two or more.

The compound 2,2-bis(4-(methacryloxypentaethoxy)phenyl)propane is commercially available as BPE-500 (trade name of Shin-Nakamura Chemical Co., Ltd.), and the compound 2,2-bis(4-(methacryloxypentadecaethoxy)phenyl)propane is commercially available as BPE-1300 (trade name of Shin-Nakamura Chemical Co., Ltd.).

Examples of photopolymerization initiators as component (C) according to the invention include aromatic ketones such as benzophenone and N,N′-tetramethyl-4,4′-diaminobenzophenone (Michler's ketone), N,N′-tetraethyl-4,4′-diaminobenzophenone, 4-methoxy-4′-dimethylaminobenzophenone, 2-benzyl-2-dimethylamino-1-(4-morpholinophenyl)-1-butanone and 2-methyl-1-[4-(methylthio)phenyl]-2-morpholino-1-propanone, quinones such as 2-ethylanthraquinone, phenanthrenequinone, 2-tert-butylanthraquinone, octamethylanthraquinone, 1,2-benzanthraquinone, 2,3-benzanthraquinone, 2-phenylanthraquinone, 2,3-diphenylanthraquinone, 1-chloroanthraquinone, 2-methylanthraquinone, 1,4-naphthoquinone, 9,10-phenanthraquinone, 2-methyl-1,4-naphthoquinone and 2,3-dimethylanthraquinone, benzoin ether compounds such as benzoin methylether, benzoin ethylether and benzoin phenylether, benzoin compounds such as benzoin, methylbenzoin and ethylbenzoin, benzyl derivatives such as benzyldimethyl ketal, 2,4,5-triarylimidazole dimers such as 2-(o-chlorophenyl)-4,5-diphenylimidazole dimer, 2-(o-chlorophenyl)-4,5-di(methoxyphenyl)imidazole dimer, 2-(o-fluorophenyl)-4,5-diphenylimidazole dimer, 2-(o-methoxyphenyl)-4,5-diphenylimidazole dimer and 2-(p-methoxyphenyl)-4,5-diphenylimidazole dimer, acridine derivatives such as 9-phenylacridine and 1,7-bis(9,9′-acridinyl)heptane, N-phenylglycine, N-phenylglycine derivatives, coumarin-based compounds, and the like.

The substituents on the aryl groups of the two 2,4,5-triarylimidazoles of the 2,4,5-triarylimidazole dimer may be the same to yield a symmetrical compound, or they may be different to yield an asymmetrical compound. Also, a thioxanthone-based compound and a tertiary amine compound may be combined, such as in a combination of diethylthioxanthone and dimethylaminobenzoic acid. Any one of these may be used alone, or two or more thereof may be used in combination.

The content of the (A) binder polymer is preferably 40-80 parts by weight and more preferably 45-70 parts by weight with respect to 100 parts by weight as the total of component (A) and component (B). If the content is less than 40 parts by weight the photocured composition will tend to be brittle, and the coatability poor for use as a photosensitive element, while if the content is greater than 80 parts by weight the photosensitivity will tend to be inadequate.

The content of the (B) photopolymerizing compound is preferably 20-60 parts by weight and more preferably 30-55 parts by weight with respect to 100 parts by weight as the total of component (A) and component (B). If the content is less than 20 parts by weight the photosensitivity will tend to be inadequate, and if it is greater than 60 parts by weight the photocured composition (for example, the cured resist film) will tend to be brittle.

In consideration of adhesion release time between the photocured composition and adherend, the content of the photopolymerizing compound represented by general formula (1) above as the essential component of component (B) is preferably 3-60 wt %, more preferably 10-50 wt % and most preferably 15-40 wt % based on the total of component (B). If this content is less than 3 wt %, the adhesion of the photocured composition (for example, cured resist film) with the adherend such as a metal foil will tend to be poor, and if it is greater than 60 wt % a longer time will tend to be necessary for release of the photocured composition.

The content of the (C) photopolymerization initiator is preferably 0.1-20 parts by weight and more preferably 0.2-10 parts by weight with respect to 100 parts by weight as the total of component (A) and component (B). If the content is less than 0.1 parts by weight the photosensitivity will tend to be inadequate, and if it is greater than 20 parts by weight the absorption by the composition on the surface of the photosensitive resin composition layer will be increased during exposure, tending to result in insufficient photocuring in the interior.

The photosensitive resin composition of the invention may, if necessary, also contain dyes such as malachite green, light photodevelopers such as tribromophenylsulfone, leuco crystal violet or the like, thermal coloring inhibitors, plasticizers such as p-toluenesulfonamide, pigments, fillers, defoaming agents, flame retardants, stabilizers, tackifiers, leveling agents, release accelerators, antioxidants, aromatics, imaging agents, thermal crosslinking agents and the like, each at about 0.01-20 parts by weight with respect to 100 parts by weight as the total of component (A) and component (B). Any of these may be used alone, or two or more thereof may be used in combination.

The photosensitive resin composition of the invention may, if necessary, be coated as a solution in a solvent such as methanol, ethanol, acetone, methyl ethyl ketone, methylcellosolve, ethylcellosolve, toluene, N,N-dimethylformamide or propyleneglycol monomethylether, or a mixture of such solvents, at a solid content of about 30-60 wt %.

The photosensitive resin composition of the invention is used after coating as a liquid resist onto a metal surface and drying, followed by covering with a protective film if necessary, or it may be used in the form of a photosensitive element. There are no particular restrictions on the aforementioned metal, and as examples there may be mentioned copper, copper-based alloys, nickel, chromium, iron, and iron-based alloys such as stainless steel. Of these, copper, copper-based alloys and iron-based alloys are preferred from the viewpoint of adhesion with the cured resist film and electroconductivity.

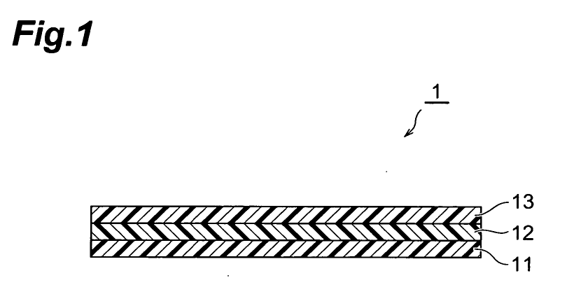

FIG. 1 is a schematic partial cross-sectional view showing a preferred embodiment of a photosensitive element according to the invention. The photosensitive element 1 has a photosensitive layer 12 consisting of a layer of the aforementioned photosensitive resin composition formed on a support 11, and a protective film 13 is laminated over the photosensitive layer 12.

The thickness of the photosensitive layer 12 will differ depending on the purpose, but the post-drying thickness is preferably 1-100 μm and more preferably 1-50 μm. If the thickness is less than 1 μm it will tend to be difficult to accomplish industrial coating, while if it is greater than 100 μm the effect of the invention will be minimal and the adhesive force and resolution will tend to be reduced.

The ultraviolet transmittance of the photosensitive layer 12 at a wavelength of 365 nm is preferably 5-75%, more preferably 7-60% and most preferably 10-40%. A transmittance of less than 5% will tend to result in inferior post-curing adhesion of the photosensitive layer 12, and a transmittance of greater than 75% will tend to result in inferior resolution. The transmittance may be measured with a UV spectrometer, and an example of a UV spectrometer is a Model 228A W beam spectrophotometer (trade name of Hitachi, Ltd.).

The support 11 of the photosensitive element 1 has a thickness of preferably 5-25 μm, more preferably 8-20 μm and most preferably 10-16 μm. If the thickness is less than 5 μm the support 11 will tend to tear during peeling of the support 11 before development, and if it is greater than 25 μm the resolution will tend to be reduced.

The haze of the support 11 is preferably 0.001-5.0, more preferably 0.001-2.0 and most preferably 0.01-1.8. A haze value of greater than 5.0 will tend to lower the resolution. The haze value is measured according to JIS K 7105, and for example, it may be measured using a commercially available turbidimeter such as NDH-1001DP (trade name of Nippon Denshoku Industries Co., Ltd.).

The support 11 may be a polymer film having heat resistance and solvent resistance, such as polyethylene terephthalate, polypropylene, polyethylene or polyester, for example.

The protective film 13 of the photosensitive element 1 has a thickness of preferably 5-30 μm, more preferably 10-28 μm and most preferably 15-25 μm. If the thickness is less than 5 μm the protective film 13 will tend to tear during lamination, and if it is greater than 30 μm the cost performance will be reduced.

The tensile strength of the protective film 13 in the lengthwise direction of the film is preferably at least 13 MPa, more preferably 13-100 MPa, even more preferably 14-100 MPa, yet more preferably 15-100 MPa and very preferably 16-100 MPa. A tensile strength of less than 13 MPa may result in tearing of the protective film 13 during lamination.

The tensile strength of the protective film 13 in the widthwise direction of the film is preferably at least 9 MPa, more preferably 9-100 MPa, even more preferably 10-100 MPa, yet more preferably 11-100 MPa and very preferably 12-100 MPa. A tensile strength of less than 9 MPa may result in tearing of the protective film 13 during lamination.

More preferably, the tensile strength of the protective film 13 in the lengthwise direction of the film is at least 13 MPa and the tensile strength in the widthwise direction of the film is at least 9 MPa.

The tensile strength may be measured according to JIS C 2318-1997(5.3.3), and for example, the measurement may be conducted using a commercially available tensile tester such as a Tensilon™ by Toyo Baldwin Co., Ltd.

Since the support 11 and protective film 13 must be removable from the photosensitive layer at a later point, they must not be surface treated to an extent that will prevent their removal, but if necessary they may be subjected to treatment to an extent that will allow their removal (such as surface roughening treatment or the like). Also, the support 11 and protective film 13 may be subjected to electrostatic treatment if necessary.

It is not essential for a photosensitive element of the invention to be provided with the protective film 13 of the aforementioned photosensitive element 1.

A photosensitive element (not shown) comprising two layers, the support 11 and the photosensitive layer 12, and the photosensitive element 1 comprising three layers, the support 11, photosensitive layer 12 and protective layer 13, may be stored by winding into a roll either directly or after lamination of a protective film on the other side of the photosensitive layer, for example.

As an example of a resist pattern forming method using the aforementioned photosensitive element, when the aforementioned protective film 13 is used, for example, there may be mentioned a method in which the protective film 13 is removed and then the photosensitive layer 12 is laminated by contact bonding with a circuit-forming board while heating. For this method, the photosensitive layer 12 is preferably laminated on the circuit-forming board under reduced pressure, from the standpoint of adhesion and shape-following properties. The surface of the laminated circuit-forming board will usually be a metal surface, but is not particularly restricted. The heating temperature for the photosensitive layer 12 is preferably 70-130° C. and the contact bonding pressure is preferably about 0.1-1.0 MPa (about 1-10 kgf/cm²), but these conditions are not restrictive. Heating of the photosensitive layer 12 at 70-130° C. as mentioned above will eliminate the need for preheating treatment of the circuit-forming board, but the circuit-forming board may still be preheated in order to further improve the laminating property.

The photosensitive layer 12 after completion of the lamination is then irradiated on the necessary sections with active light rays through a photomask pattern which is either a negative or positive mask, known as an “artwork”. Another method is one using an NC-controlled spot irradiator for direct active light ray exposure without an intervening film.

If the support 11 on the photosensitive layer 12 is transparent to the active light rays, the active light rays may be directly irradiated. If the support 11 is opaque to the active light rays, the support 11 is preferably removed. The light source for the active light rays may be a publicly known light source such as, for example, a carbon arc lamp, mercury vapor arc lamp, ultra-high pressure mercury lamp, high pressure mercury lamp, xenon lamp or the like, which efficiently emits ultraviolet rays. There may also be used a lamp that efficiently emits visible light rays, such as a photographic flood lamp or sun lamp.

When the support 11 remains on the photosensitive layer 12 after exposure, the support 11 is then removed and the unexposed sections are removed by development such as wet development or dry development, to form a resist pattern. In the case of wet development, a developing solution suitable for photosensitive resin compositions may be used, such as an aqueous alkali solution, aqueous developing solution or organic solvent, and development may be accomplished by a publicly known method such as spraying, reciprocal dipping, brushing, slapping or the like. The developing solution used is one which is safe and stable and easily manageable, such as an aqueous alkali solution.

The base used in the aqueous alkali solution may be, for example, an alkali hydroxide such as a hydroxide of lithium, sodium or potassium, an alkali carbonate such as a carbonate or bicarbonate of lithium, sodium, potassium or ammonium, an alkali metal phosphate such as potassium phosphate or sodium phosphate, or an alkali metal pyrophosphate such as sodium pyrophosphate or potassium pyrophosphate. The aqueous alkali solution used for development is preferably a 0.1-5 wt % sodium carbonate dilute solution, a 0.1-5 wt % potassium carbonate dilute solution, a 0.1-5 wt % sodium hydroxide dilute solution or a 0.1-5 wt % sodium tetraborate dilute solution. The pH of the aqueous alkali solution used for development is preferably in the range of 9-11, and the temperature is adjusted as appropriate for the developing property of the photosensitive layer. The aqueous alkali solution may also contain added surfactants, defoaming agents, and small amounts of organic solvent to accelerate development.

As aqueous developing solutions there may be mentioned mixtures of one or more organic solvents with water or aqueous alkali solutions. Here, the alkali substance may be any of the substances mentioned above as well as, for example, borax, sodium metasilicate, tetramethylammonium hydroxide, ethanolamine, ethylenediamine, diethylenetriamine, 2-amino-2-hydroxymethyl-1,3-propanediol, 1,3-diaminopropanol-2, morpholine or the like. The pH of the developing solution is preferably as low as possible in a range allowing sufficient development of the resist, and this is preferably pH 8-12 and more preferably pH 9-10.

As examples of organic solvents there may be mentioned triacetone alcohol, acetone, ethyl acetate, alkoxyethanols with C1-4 alkoxy groups, ethyl alcohol, isopropyl alcohol, butyl alcohol, diethyleneglycol monomethylether, diethyleneglycol monoethylether, diethyleneglycol monobutylether and the like. Any of these may be used alone, or two or more thereof may be used in combination. The concentration of the organic solvent is normally preferred to be 2-90 wt %, and the temperature may be adjusted as appropriate for the developing property. The aqueous developing solution may also contain small amounts of added surfactants, defoaming agents and the like.

As examples of organic solvent-based developing solutions there may be mentioned 1,1,1-trichloroethane, N-methylpyrrolidone, N,N-dimethylformamide, cyclohexanone, methyl isobutyl ketone, γ-butyrolactone and the like. Water is preferably added to these organic solvents in a range of 1-20 wt % for anti-flammability.

Two or more developing methods may also be carried out together if necessary. The developing system may be a dip system, a paddle system, a spray system such as a high-pressure spray system, or brushing, slapping or the like. A high-pressure spray system is most suitable among these for improved resolution.

As post-developing treatment, the resist pattern may be further cured if necessary by heating at about 60-250° C. or by exposure at about 0.2-10 mJ/cm².

For etching of the metal surface after development there may be employed an etching solution such as a copper(II) chloride solution, iron(II) chloride solution, alkali etching solution or hydrogen peroxide-based etching solution, but an iron(II) chloride solution is preferred from the viewpoint of a satisfactory etch factor.

For production of a printed circuit board using a photosensitive element of the invention, the surface of the circuit-forming board is treated by a publicly known process such as etching or plating using the developed resist pattern as a mask. As examples of plating methods there may be mentioned copper plating such as copper sulfate plating and copper pyrophosphate plating, solder plating such as high throw solder plating, nickel plating such as Watt bath (nickel sulfate-nickel chloride) plating or nickel sulfaminate plating, and gold plating such as hard gold plating or soft gold plating.

The resist pattern is then released, for example, with an aqueous solution of stronger alkalinity than the aqueous alkali solution used for development. The strongly alkaline aqueous solution used here may be, for example, a 1-10 wt % sodium hydroxide aqueous solution or a 1-10 wt % potassium hydroxide aqueous solution. The releasing system used may be, for example, a dip system, spray system or the like, and such dip and spray systems may be used alone or in combination. The printed circuit board on which the resist pattern has been formed may also be a multilayer printed circuit board.

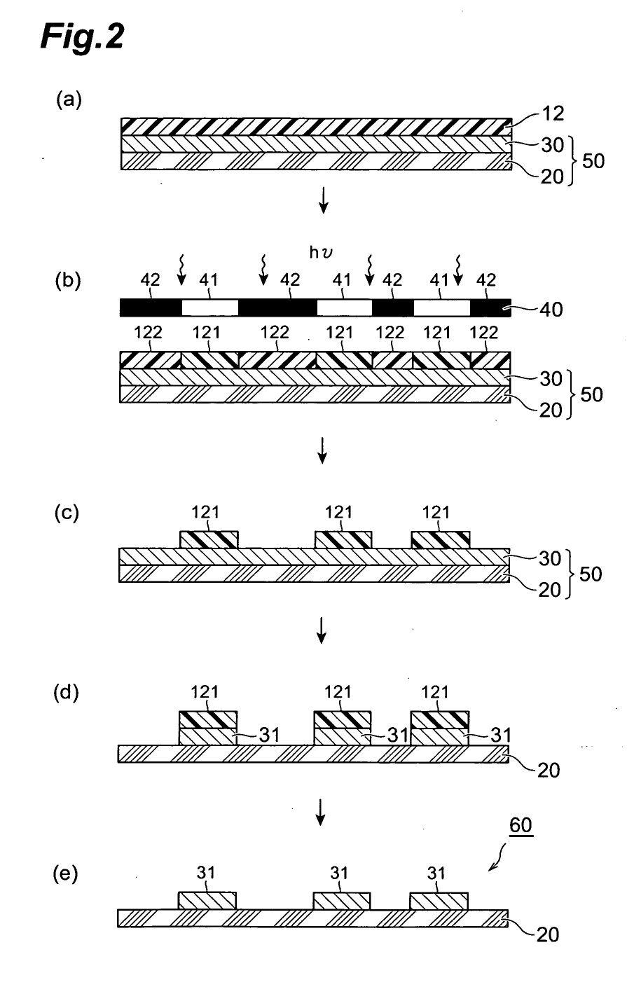

A preferred mode of a printed circuit board production process according to the invention will now be explained with reference to FIG. 2. First, in step (a) of FIG. 2, the protective film 13 of the photosensitive element 1 shown in FIG. 1 is removed while laminating a photosensitive element 1 on the circuit-forming board 50 comprising an insulating sheet 20 and a metal foil 30, such as laminated board, in such a manner that the metal foil 30 and photosensitive layer 12 are in direct contact. The support 11 is then peeled off from the photosensitive layer 12 to obtain a laminated body.

Next, in step (b) of FIG. 2, active rays hv are irradiated onto the photosensitive layer 12 of the laminated body through a photomask 40, for photocuring of prescribed sections of the photosensitive layer. The transparent sections 41 of the photomask 40 which are transparent to the active light rays hv have the same shape as the desired circuit pattern 31 described hereunder. Thus, irradiation with the active light rays hv cures the exposed sections of the photosensitive layer 12 to form cured sections 121 having the same shape as the circuit pattern 31.

Next, in step (c) of FIG. 2, the developing treatment described above is carried out to remove the non-cured sections 122 of the photosensitive layer 12 that have not been exposed and cured due to the presence of the opaque sections 42 of the photomask 40 that are opaque to the active light rays hv. This results in adhesive formation of the cured sections 121 of the photosensitive layer having the prescribed pattern on the metal foil 30 of the circuit-forming board 50, to yield a cured resist film (resist pattern).

Next, in step (d) of FIG. 2, the etching described earlier is carried out to remove the sections of the metal foil 30 that are not covered with the cured sections 121, thereby leaving only the sections 31 covered by the cured sections 121 on the insulating sheet 20.

Finally, in step (e) of FIG. 2, the strongly alkaline aqueous solution described above is used to release and remove the cured sections 121, to obtain a printed circuit board 60 having the prescribed circuit pattern 31 on the insulating sheet 20.

The above explanation of a preferred mode of the invention is not intended to restrict the scope of the invention to this particular mode.

### EXAMPLES

The present invention will now be explained using examples.

### Examples 1, 2 and Comparative Examples 1, 2

A solution containing binder polymer (a) as component (A) shown in Table 1, the components (B) and components (C) shown in Table 2, and other added components were combined in the mixing ratios (weight ratios) shown in the table to obtain a photosensitive resin composition solution. The weight-average molecular weight of the binder polymer was calculated from a calibration curve using standard polystyrene based on gel permeation chromatography (GPC). The GPC conditions were as follows.

[GPC conditions]
Pump: Hitachi Model L-6000 (product of Hitachi, Ltd.)
Column: Gelpack GL-R420+Gelpack GL-R430+Gelpack GL-R440 (total of 3 columns) (all trade names of Hitachi Chemical Co., Ltd.).
Eluant: tetrahydrofuran
Measuring temperature: room temperature
Flow rate: 2.05 ml/min

Detector: Hitachi Model L-3300 RI (product of Hitachi, Ltd.)

TABLE 1
Solutions containing component (A)

Solution of binder polymer (a) (copolymer of methacrylic acid/methyl
methacrylate/styrene = 28/60/12 (weight ratio)) dissolved in a mixed
solvent of methylcellosolve/toluene = 6/4 (weight ratio) to a non-volatile
component content of 50 wt % (Binder polymer (a) properties: weight-
average molecular weight = 60,000, glass transition temperature =
124° C., acid value = 183 mgKOH/g)
Solution of binder polymer (b) (copolymer of methacrylic acid/methyl
methacrylate/styrene = 28/60/12 (weight ratio)) dissolved in a mixed
solvent of methylcellosolve/toluene = 6/4 (weight ratio) to a non-volatile
component content of 50 wt % (Binder polymer (b) properties: weight-
average molecular weight = 55,000, glass transition temperature =
124° C., acid value = 183 mgKOH/g)
Solution of binder polymer (c) (copolymer of methacrylic acid/methyl
methacrylate/styrene = 28/60/12 (weight ratio)) dissolved in a mixed
solvent of methylcellosolve/toluene = 6/4 (weight ratio) to a non-volatile
component content of 50 wt % (Binder polymer (c) properties: weight-
average molecular weight = 40,000, glass transition temperature =
124° C., acid value = 183 mgKOH/g)
Solution of binder polymer (d) (copolymer of methacrylic acid/methyl
methacrylate/styrene = 28/60/12 (weight ratio)) dissolved in a mixed
solvent of methylcellosolve/toluene = 6/4 (weight ratio) to a non-volatile
component content of 50 wt % (Binder polymer (d) properties: weight-
average molecular weight = 100,000, glass transition temperature =
124° C., acid value = 183 mgKOH/g)
Solution of binder polymer (e) (copolymer of methacrylic acid/methyl
methacrylate/styrene = 22/72/6 (weight ratio)) dissolved in a mixed
solvent of methylcellosolve/toluene = 6/4 (weight ratio) to a non-volatile
component content of 50 wt % (Binder polymer (e) properties: weight-
average molecular weight = 100,000, glass transition temperature =
120° C., acid value = 144 mgKOH/g)

TABLE 2

| | | Example | | Comp. Ex. | |
|---|---|---|---|---|---|
| | | 1 | 2 | 1 | 2 |
| Component (A) | Binder polymer (a) | 60 *1 | 60 *1 | 60 *1 | 60 *1 |
| Component (B) | A-GLY-0606PE *2 | 10 | — | — | — |
| | A-GLY-0909PE *3 | — | 10 | — | — |
| | BPE-500 *4 | 30 | 30 | 40 | — |
| | APG-400 *5 | — | — | — | 40 |

| | | |
|---|---|---|
| Component (C) | 2-(o-chlorophenyl)-4,5- | 3.0 |
| | diphenylimidazole dimer | |
| | N,N′-tetraethyl-4,4′- | 0.15 |
| | diaminobenzophenone | |
| Coupler | leuco crystal violet | 0.5 |
| | tribromophenylsulfone | 0.5 |
| Dye | malachite green | 0.05 |
| Solvent | methyl ethyl ketone | 10 |
| | toluene | 10 |
| | methanol | 5 |

*1: Parts by solid weight
*2: Compound of general formula (2) above wherein R¹ = hydrogen, X¹ = propylene, X² = ethylene, l + m + n = 6 (average) and p + q + r = 6 (average) (Shin-Nakamura Chemical Corp.)
*3: Compound of general formula (2) above wherein R¹ = hydrogen, X¹ = propylene, X² = ethylene, l + m + n = 9 (average) and p + q + r = 9 (average) (Shin-nakamura Chemical Corp.)
*4: 2,2-bis(4-(methacryloxypentaethoxy)phenyl)propane (Shin-Nakamura Chemical Co., Ltd.)
*5: Polypropyleneglycol diacrylate (Number of repeating propylene glycol chains (—O—CH(CH₃)—CH₂—) = 7 (average) (Shin-Nakamura Chemical Co., Ltd.)

Next, the obtained photosensitive resin composition solution was evenly coated onto a 16 μm-thick polyethylene terephthalate film (haze: 1.7%, GS-16™, Teijin, Ltd.), and dried for 10 minutes using a hot-air convection drier at 100° C. to obtain a photosensitive element protected with a polyethylene protective film. The post-drying thickness of the photosensitive layer was 30 μm.

Separately, the copper surface of a copper-clad laminate having a copper foil (35 μm thickness) laminated on both sides of a glass epoxy material (MCL-E-679™, Hitachi Chemical Co., Ltd.) was polished using a polishing machine (product of Sankei Co., Ltd.) with a #600 equivalent brush, and after rinsing with water and drying with an air stream, the obtained copper-clad laminate was heated to 80° C. and the protective film was peeled off while laminating the aforementioned photosensitive layer on the copper surface at a speed of 1.5 m/min, using a heat roll at 110° C.

For evaluation of the adhesive property, there was prepared a bonded laminate of a phototool with a 21-step Stouffer tablet and a phototool bearing a circuit pattern with a line width/space width of 6/400-47/400 (units: μm) as a negative for evaluation of the adhesive property. The laminated photosensitive layer was exposed through a photomask using an energy dose sufficient to leave step number 7.0 after development of the 21-step Stouffer tablet. The adhesive property was evaluated based on the smallest line width without line breakage, peeling or twisting resulting from the developing treatment. A smaller value for the adhesive property evaluation is a more satisfactory value; the results thereof are shown in Table 3.

TABLE 3

| | | | Comp. | Comp. |
|---|---|---|---|---|
| | Example 1 | Example 2 | Ex. 1 | Ex. 2 |
| Adhesive property (μm) | 20 | 20 | 25 | 25 |
| Resolution (μm) | 35 | 35 | 35 | 40 |
| Cross-cut property | 10 | 10 | 8 | 8 |

For evaluation of the resolution, there was prepared a bonded laminate of a phototool with a 21-step Stouffer tablet and a phototool bearing a circuit pattern with a line width/space width of 6/6-47/47 (units: μm) as a negative for evaluation of the resolution. The laminated photosensitive layer was exposed through a photomask using an energy dose sufficient to leave step number 7.0 after development of the 21-step Stouffer tablet. The resolution was evaluated based on the smallest space width between lines which allowed clean removal of the unexposed sections by the developing treatment. A smaller value for the resolution evaluation is a more satisfactory value, and the results thereof are shown in Table 3.

The photosensitive layer was exposed and developed with an exposure dose to reveal number 7 of the 21-step Stouffer tablet, and was then subjected to a cross-cut test (JIS-K-5400). The results are shown in Table 3. The cross-cut test is a test wherein a cutter guide is used for cutting in a tessellated fashion at the center of the circuit-forming board on which the photosensitive element has been laminated, in such a manner that 11 parallel lines are drawn in both orthogonal directions at a spacing of 1 mm in order to form 100 squares in a square area of 1 cm², and this cut region is evaluated. The cut region was produced by pulling the blade tip of the cutter knife at a constant speed for 0.5 sec for each cut, while maintaining it at a fixed angle in a range of 35-45° with respect to the photosensitive element, and penetrating the photosensitive layer to reach to the circuit-forming board. The condition of the cut was evaluated in the following manner.
10 points: Thin cuts with both sides smooth, and no peeling at cut cross points or at the divisions between squares.
8 points: Slight peeling at cut cross points, no peeling at divisions between squares, and lost area of no more than 5% of the total square area.
6 points: Peeling at both sides and cross points of cuts, and lost area of 5-15% of the total square area.
4 points: Wide peeling caused by cutting, and lost area of 15-35% of the total square area.
2 points: Wider peeling caused by cutting than with 4 points, and lost area of 35-65% of the total square area.
0 points: Lost area of 65% or greater of the total square area.

As clearly seen in Table 2, the photosensitive layers of Examples 1 and 2 had excellent adhesion and resolution, as well as satisfactory cross cutting properties.

### Examples 3-9, and Comparative Examples 3-5

Solutions containing binder polymers (b), (c) or (d) as component (A) shown in Table 1, components (C) shown in Table 4, and other added components were combined in the mixing ratios (weight ratios) shown in the table, and component (B) was dissolved therein in the mixing ratios shown in the table, to obtain photosensitive resin composition solutions.

TABLE 4

| | | Example | | | | | | | Comp. Ex. | | |
|---|---|---|---|---|---|---|---|---|---|---|---|
| | | 3 | 4 | 5 | 6 | 7 | 8 | 9 | 3 | 4 | 5 |
| Component | Binder polymer (b) | 60 *6 | 60 *6 | — | — | — | — | — | — | 60 *6 | — |
| (A) | Binder polymer (c) | — | — | 60 *6 | 60 *6 | — | — | — | — | — | 60 *6 |
| | Binder polymer (d) | — | — | — | — | 60 *6 | 60 *6 | — | 60 *6 | — | — |
| | Binder polymer (e) | — | — | — | — | — | — | 60 *6 | — | — | — |
| Component | BPE-500 *7 | 30 | 30 | 30 | 30 | 30 | 30 | 30 | 30 | 30 | 30 |
| (B) | APG-400 *8 | — | — | — | — | — | — | — | 10 | 10 | 10 |
| | A-GLY-3E *9 | 10 | — | 10 | — | 10 | — | 10 | — | — | — |
| | A-GLY-9E *10 | — | 10 | — | 10 | — | 10 | — | — | — | — |

| | | |
|---|---|---|
| Component | 2-(o-chlorophenyl)-4,5- | 3.0 |
| (C) | diphenylimidazole dimer | |
| | N,N′-tetraethyl-4,4′- | 0.15 |
| | diaminobenzophenone | |
| Coupler | leuco crystal violet | 0.5 |
| Dye | malachite green | 0.05 |
| Solvent | methyl ethyl ketone | 10 |
| | toluene | 10 |
| | methanol | 5 |

*6: Parts by solid weight
*7: 2,2-bis(4-(methacryloxypentaethoxy)phenyl)propane (Shin-Nakamura Chemical Co., Ltd.)
*8: Polypropyleneglycol diacrylate (Number of repeating propylene glycol chains (—O—CH(CH₃)—CH₂—) = 7 (average) (Shin-Nakamura Chemical Co., Ltd.)
*9: Compound of general formula (1) above wherein R¹ = hydrogen, X = ethylene and i + j + k = 3 (average) (Shin-Nakamura Chemical Corp.)
*10: Compound of general formula (1) above wherein R¹ = hydrogen, X = ethylene and i + j + k = 9 (average) (Shin-Nakamura Chemical Corp.)

Next, the obtained photosensitive resin composition solution was evenly coated onto a 16 μm-thick polyethylene terephthalate film (haze: 1.7%, GS-16™, Teijin, Ltd.), and dried for 10 minutes using a hot-air convection drier at 100° C. to obtain a photosensitive element protected with a polyethylene protective film. The post-drying thickness of the photosensitive layer was 40 μm.

Separately, the copper surface of a copper-clad laminate having a copper foil (35 μm thickness) laminated on both sides of a glass epoxy material (MCL-E-679™, Hitachi Chemical Co., Ltd.) was polished using a polishing machine (product of Sankei Co., Ltd.) with a #600 equivalent brush, and after rinsing with water and drying with an air stream, the obtained copper-clad laminate was heated to 80° C. and the protective film was peeled off while laminating the aforementioned photosensitive layer on the copper surface at a speed of 1.5 m/min, using a heat roll at 110° C.

The adhesion, resolution and cross cutting property were evaluated in the same manner as Examples 1 and 2 and Comparative Examples 1 and 2. The results are shown in Table 5.

TABLE 5

| | Example | | | | | | | Comp. Ex. | | |
|---|---|---|---|---|---|---|---|---|---|---|
| | 3 | 4 | 5 | 6 | 7 | 8 | 9 | 3 | 4 | 5 |
| Adhesion (μm) | 27 | 27 | 27 | 27 | 27 | 27 | 30 | 32 | 32 | 32 |
| Resolution (μm) | 40 | 40 | 37 | 37 | 45 | 45 | 47 | 47 | 45 | 42 |
| Cross cutting property | 8 | 8 | 8 | 8 | 8 | 8 | 8 | 6 | 6 | 6 |
| Tent breakage rate | 25 | 20 | 30 | 25 | 20 | 15 | 20 | 40 | 50 | 60 |
| (%) | | | | | | | | | | |

Also, a laminated body of the photosensitive resin composition on a base material with three 4 mm-diameter holes was laminated onto both sides of a 1.6 mm-thick copper clad laminate, and this was exposed at the energy dose mentioned above twice for 60 seconds each of development. After development, the number of broken holes among the total of 18 holes was evaluated as the tent breakage rate as defined by formula (4) below, and this was used as an index of the tent reliability.
Tent breakage rate (%)=((number of broken holes)/18 holes)×100 (4)

As clearly seen in Table 5, the photosensitive layers of Examples 3-8 had excellent adhesion and cross cutting properties, as well as excellent tent properties.

### INDUSTRIAL APPLICABILITY

According to the invention there are provided a photosensitive resin composition that can yield a cured resist film with sufficiently excellent adhesive properties, as well as a photosensitive element, a resist pattern forming method and a print circuit board production process employing it.

1. A photosensitive resin composition comprising:
(A) a binder polymer,
(B) a photopolymerizing compound with at least one polymerizable ethylenic unsaturated group in the molecule and
(C) a photopolymerization initiator,
wherein component (B) contains a compound represented by the following general formula (1): 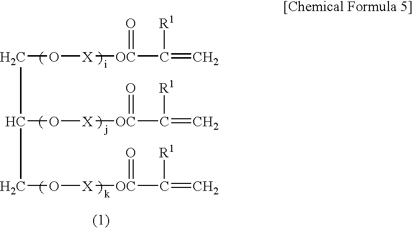
(wherein the three R¹ groups each independently represent hydrogen or methyl, the three X groups each independently represent C2-6 alkylene and i, j and k each independently represent an integer of 1-14).

2. A photosensitive resin composition according to claim 1, wherein the alkylene group of component (B) is ethylene or propylene.

3. A photosensitive resin composition according to claim 1, wherein the compound represented by general formula (1) above is a compound represented by the following general formula (2): 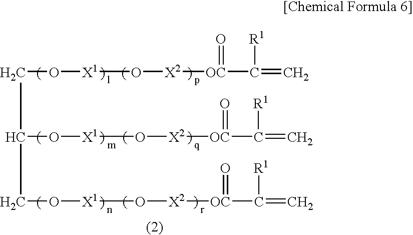
(wherein the three R¹ groups each independently represent hydrogen or methyl, the three X¹ and three X² groups each independently represent C2-6 alkylene and l, m, n, p, q and r each independently represent an integer of 1-7).

4. A photosensitive resin composition according to claim 3, wherein X¹ and X² on the same chain in component (B) are different alkylene groups.

5. A photosensitive resin composition according to claim 3, wherein either of X¹ and X² in component (B) is an ethylene group and the other is a propylene group.

6. A photosensitive resin composition according to claim 3, wherein l, m, n, p, q and r in component (B) each independently represent an integer of 1-3.

7. A photosensitive resin composition according to claim 1, wherein the weight-average molecular weight of component (A) is 10,000-95,000.

8. A photosensitive resin composition according to claim 1, which has a component (A) content of 40-80 parts by weight, a component (B) content of 20-60 parts by weight and a component (C) content of 0.1-20 parts by weight with respect to 100 parts by weight as the total of component (A) and component (B).

9. A photosensitive resin composition according to claim 1, wherein the content of the compound represented by general formula (1) above is 5-60 wt % with respect to the total of component (B).

10. A photosensitive element provided with a support and a photosensitive layer comprising a photosensitive resin composition according to claim 1 formed on said support.

11. A photosensitive element according to claim 10, wherein the thickness of said support is 5-25 μm.

12. A photosensitive element according to claim 10 wherein the haze of said support is 0.001-5.0.

13. A photosensitive element according to claim 10, wherein said photosensitive layer has an ultraviolet light transmittance of 5-75% at a wavelength of 365 nm.

14. A photosensitive element according to claim 10, which is further provided with a protective film on said photosensitive layer.

15. A photosensitive element according to claim 14, wherein the thickness of said protective film is 5-30 μm.

16. A photosensitive element according to claim 14, wherein the tensile strength of said protective film in the lengthwise direction of the film is at least 13 MPa.

17. A photosensitive element according to claim 14, wherein the tensile strength of said protective film in the widthwise direction of the film is at least 9 MPa.

18. A resist pattern forming method wherein a photosensitive layer for a photosensitive element according to claim 10 is laminated on a circuit-forming board and active light rays are irradiated onto prescribed sections of said photosensitive layer for photocuring of the exposed sections, after which the non-exposed sections of said photosensitive layer are removed.

19. A resist pattern forming method wherein the protective film of a photosensitive element according to claim 14 is released at the time the photosensitive layer of said photosensitive element is laminated on a circuit-forming board, and active light rays are irradiated onto prescribed sections of said photosensitive layer for photocuring of the exposed sections, after which the non-exposed sections of said photosensitive layer are removed.

20. A printed circuit board production process wherein a circuit-forming board having a resist pattern formed thereon by a resist pattern forming method according to claim 18 is etched or plated.
